(19) United States
(12) Patent Application Publication
(10) Pub. No.: US 2024/0428048 A1
(43) Pub. Date: Dec. 26, 2024

(54) IN-MEMORY PROTECTION FOR NEURAL NETWORKS

(71) Applicant: Intel Corporation, Santa Clara, CA (US)

(72) Inventors: Wenjie Wang; Yi Zhang; Yi Qian; Wanglei Shen; Junjie Li; Lingyun Zhu

(21) Appl. No.: 18/574,786

(22) PCT Filed: Nov. 24, 2021
(86) PCT No.: PCT/CN2021/132707

§ 371 Date: Feb. 1, 2024

(51) Int. Cl. G06N 3/04

(52) U.S. Cl. CPC G06N 3/04

(57) ABSTRACT

Technology providing in-memory neural network protection can include a memory to store a neural network, and a processor executing instructions to generate a neural network memory structure having a plurality of memory blocks in the memory, scatter the neural network among the plurality of memory blocks based on a randomized memory storage pattern, and reshuffle the neural network among the plurality of memory blocks based on a neural network memory access pattern. Scattering the neural network model can include dividing each layer of the neural network into a plurality of chunks, for each layer, selecting, for each chunk of the plurality of chunks, one of the plurality of memory blocks based on the randomized memory storage pattern, and storing each chunk in the respective selected memory block. The plurality of memory blocks can be organized into a groups of memory blocks and be divided between stack space and heap space.

### TECHNICAL FIELD

Embodiments generally relate to computing systems. More particularly, embodiments relate to performance-enhanced technology for protecting neural networks and related data when deployed, for example, in edge systems.

### BACKGROUND

Neural networks are increasingly being used in deep learning/artificial intelligence (AI) applications. Deployment of neural networks in AI applications, however, can result in vulnerabilities in which various aspects of the neural networks such as, e.g., network structure, trained weights and parameters, and other network data can be compromised by malicious parties, particularly when the AI application is executing. Protection of neural networks from such vulnerabilities can be especially difficult when neural network deployment extends beyond backend systems or even centralized servers to edge devices and other off-premises systems.

### BRIEF DESCRIPTION OF THE DRAWINGS

The various advantages of the embodiments will become apparent to one skilled in the art by reading the following specification and appended claims, and by referencing the following drawings, in which:

FIG. 1 provides a block diagram illustrating an overview of an example computing system for in-memory neural network protection according to one or more embodiments;

FIGS. 2A-2C provide diagrams of examples of neural network memory structures according to one or more embodiments;

FIGS. 3A-3B provide diagrams of examples of scattering a neural network in a neural network memory structure according to one or more embodiments;

FIG. 3C provides a diagram illustrating an example of an encryption key table for an in-memory neural network protection system according to one or more embodiments;

FIG. 4 provides a flow diagram illustrating an example process flow for scattering a neural network in a neural network memory structure according to one or more embodiments;

FIGS. 5A-5C provide flow diagrams illustrating example process flows for reshuffling a neural network with key management in a neural network memory structure according to one or more embodiments;

FIGS. 6A-6C provide flowcharts illustrating example methods relating to in-memory neural network protection according to one or more embodiments;

FIG. 7 is a block diagram illustrating an example of a computing system for in-memory neural network protection according to one or more embodiments;

FIG. 8 is a block diagram illustrating an example of a semiconductor apparatus according to one or more embodiments;

FIG. 9 is a block diagram illustrating an example of a processor according to one or more embodiments; and

FIG. 10 is a block diagram illustrating an example of a multiprocessor-based computing system according to one or more embodiments.

### DESCRIPTION OF EMBODIMENTS

A performance-enhanced computing system as described herein provides technology to scatter (e.g., scramble) a neural network and data across the memory of the operating device. A memory structure with memory blocks for holding the neural network can be generated. The technology can include splitting the neural network by layers and then splitting the data of the same layer into various data chunks. The data chunks can be randomly stored across the memory structure. In addition, the neural network can be further shuffled (reshuffled) within the memory structure, to camouflage the neural network data memory access pattern (e.g., by making the neural network memory access pattern similar to the memory access pattern of the system or device). The data chunks can be encrypted with a key (e.g., a symmetric key) chosen from a series of keys that can be refreshed over time. By scattering the neural network and associated data, and reshuffling the network at various intervals, the technology significantly increases the protection of an operational neural network against malicious users attempting to sniff or scan the memory data by increasing the difficulty for such malicious users to determine memory accesses or retrieve data used in the neural network.

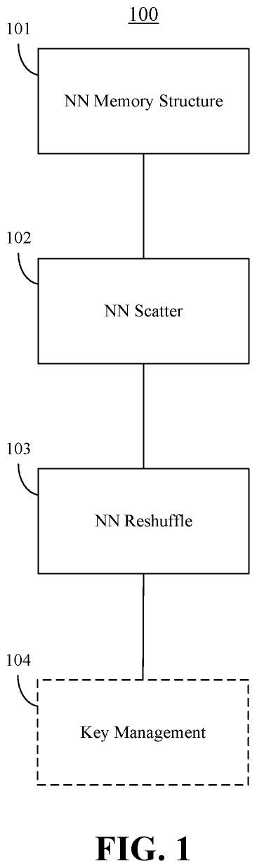

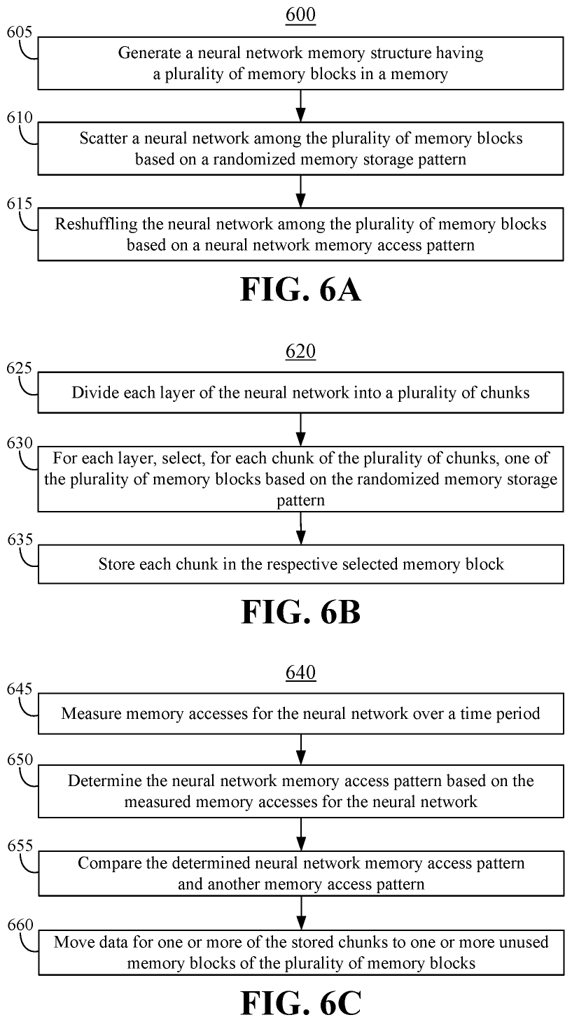

FIG. 1 provides a block diagram illustrating an overview of an example computing system 100 for in-memory neural network protection according to one or more embodiments, with reference to components and features described herein including but not limited to the figures and associated description. The system 100 operates in conjunction with an executing AI application that employs a neural network. The system 100 can include a neural network (NN) memory structure module 101, a NN scatter module 102, and a NN reshuffle module 103. In some embodiments, the system 100 can also include a key management module 104. The system 100 can also include a processor (not shown in FIG. 1) for executing one or more programs to carry out the functions of the system 100—including functions of the NN memory structure module 101, the NN scatter module 102, the NN reshuffle module 103, and/or the key management module 104. Each of the NN memory structure module 101, the NN scatter module 102, the NN reshuffle module 103 and/or the key management module 104 can be performed by or under direction of an operating system, such as, e.g., an operating system running on the system 100 or on the system 10 (described herein with reference to FIG. 7). More particularly, each of the NN memory structure module 101, the NN scatter module 102, the NN reshuffle module 103 and/or the key management module 104 can be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), general purpose microprocessor or transistor-transistor logic (TTL) technology, or any combination thereof. Moreover, the configurable and/or fixed-functionality hardware may be implemented via complementary metal oxide semiconductor (CMOS) technology.

For example, computer program code to carry out operations performed by the NN memory structure module 101, the NN scatter module 102, the NN reshuffle module 103 and/or the key management module 104 can be written in any combination of one or more programming languages, including an object oriented programming language such as JAVA, SMALLTALK, C++ or the like and conventional procedural programming languages, such as the “C” programming language or similar programming languages. Additionally, logic instructions can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

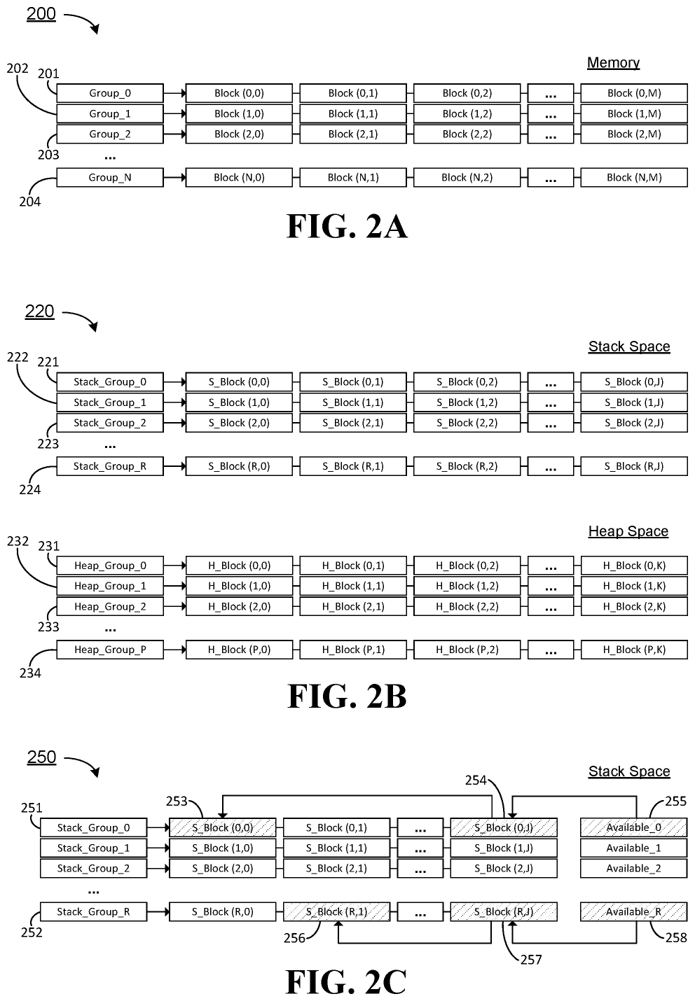

The system 100 is configured to execute an AI application that includes (or otherwise employs or utilizes) a neural network. For example, the system 100 (via the AI application) loads the neural network into memory, and the AI application reads the neural network in memory in performing the AI process. The modules 101, 102, 103 and 104 of FIG. 1 can be defined as part of a scatter/reshuffle application called by the operating system, or integrated into the AI application, etc. The NN memory structure module 101 operates to create or generate a memory structure within one or more memory space(s), where the memory space(s) are used to hold the neural network and the associated NN data (including neural network structure, trained weights and parameters, and other NN data used or generated) while the AI application is executing. The memory spaces can include a stack space and/or a heap space. The stack space is typically a static space that can be allocated within a global memory region by the system 100 (e.g., by the operating system). The heap space is typically created dynamically by the AI application, and can be allocated during execution as space is needed. The memory structure includes a plurality of memory blocks organized into groups of memory blocks. Each group has a plurality of memory blocks, where the memory blocks in a group can be of the same size block, and the size of memory blocks can vary group-to-group. Each memory space, such as, e.g., a stack space and a heap space, can have its own groups of memory blocks, where all groups of memory blocks can be utilized in the memory structure. Further details regarding the neural network memory structure are provided with reference to FIGS. 2A-2C herein.

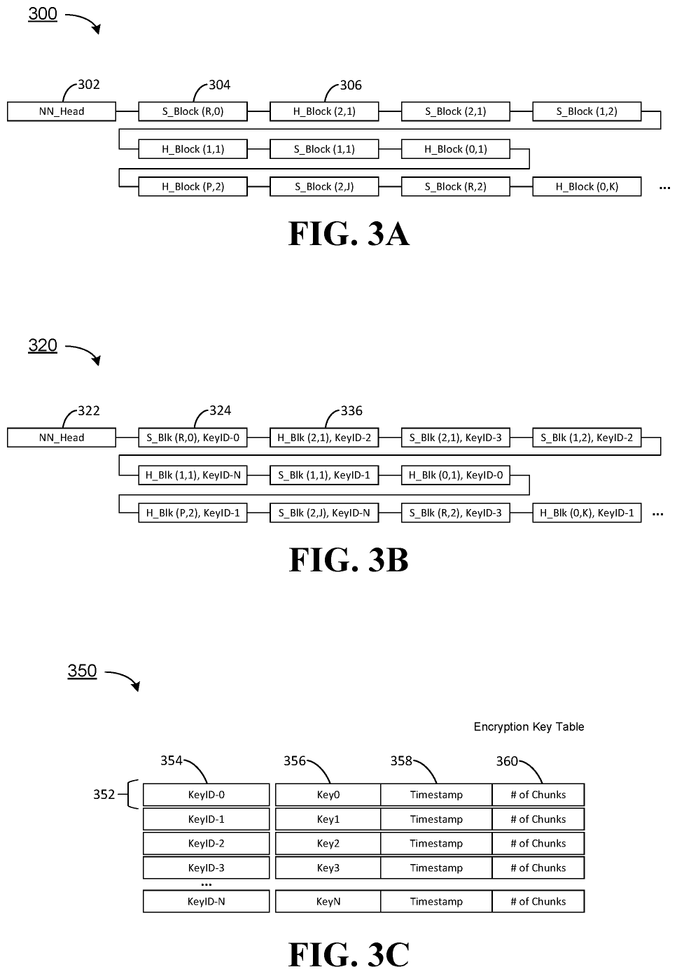

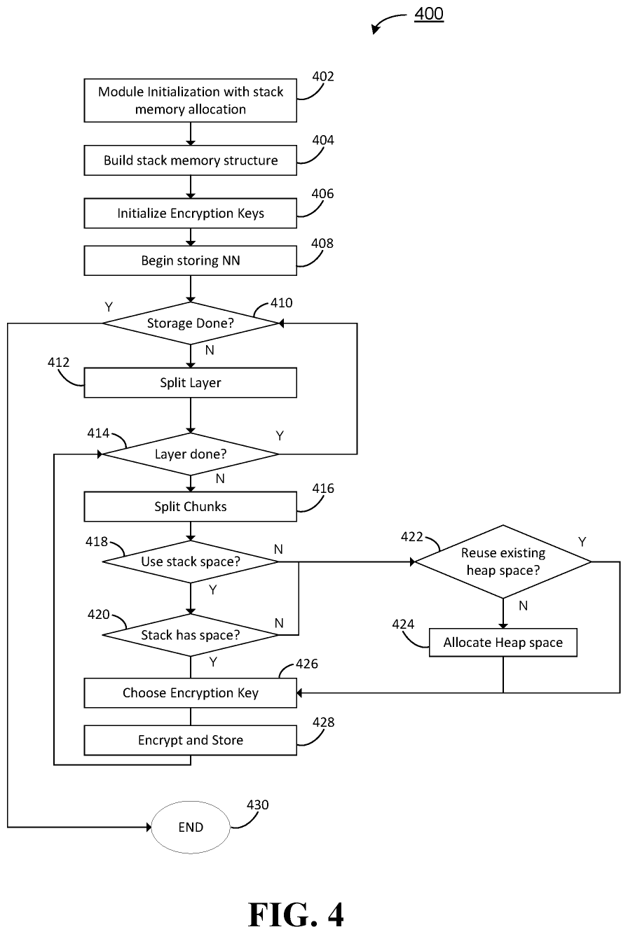

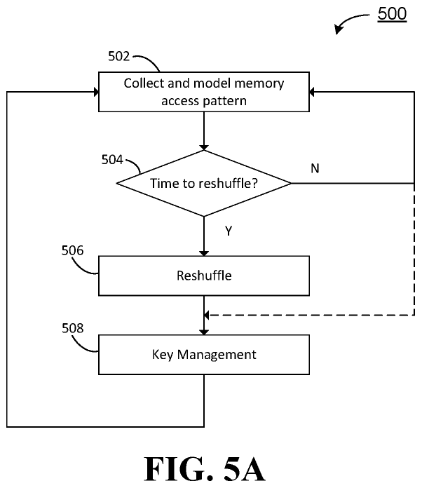

The NN scatter module 102 operates to divide a neural network that is loaded by the AI application into chunks for placement in the memory structure during execution. As the neural network is being loaded into memory, the neural network is divided into layers, and the layers (with respective weights, parameters and data) are divided into chunks of data. Memory blocks of the memory structure are selected for storing the chunks of data, where the blocks can be selected based on a randomized memory storage pattern. The chunks of data are stored in the selected memory blocks according to the random pattern. The chunks of data can be encrypted based on assigned key(s), which can be assigned to blocks, groups of blocks, etc. Further details regarding scattering the neural network are provided with reference to FIGS. 3A-3C and FIG. 4 herein.

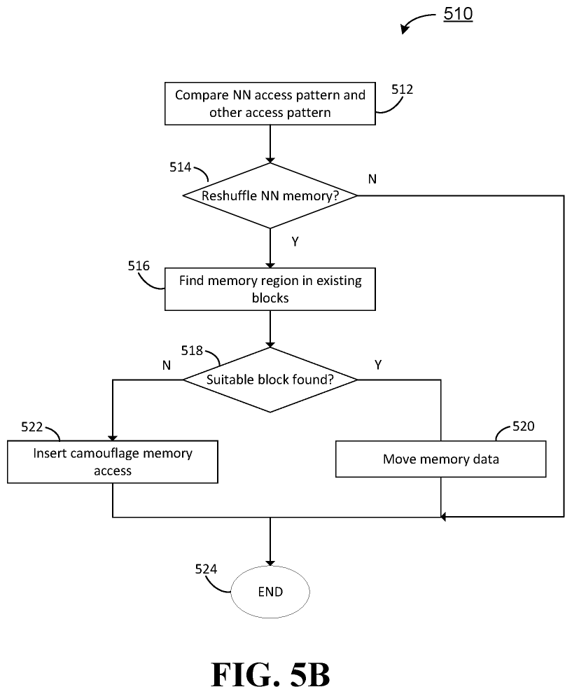

The NN reshuffle module 103 operates to move some of the data chunks among memory blocks during execution of the AI application. Memory accesses for the neural network are measured over a time period during execution and a neural network memory access pattern is determined based on the measured memory accesses. The neural network memory access pattern is compared to another memory access pattern (such as, e.g., the application memory access pattern, or the overall memory access pattern for the system or device). Based on the comparison, data for one or more of the stored chunks are moved to one or more unused memory blocks. Further details regarding reshuffling the neural network are provided with reference to FIGS. 5A-5B herein.

The key management module 104 operates to manage encryption keys used for the scatter and reshuffle processes. Encryption keys are generated, assigned to memory blocks, tracked, and retired once the keys expire. Further details regarding key management are provided with reference to FIGS. 3C, 5A and 5C herein.

FIGS. 2A-2C provide diagrams of examples of neural network memory data structures according to one or more embodiments, with reference to components and features described herein including but not limited to the figures and associated description. The illustrated memory structures are created or generated within one or more memory space(s), where the memory space(s) are used to hold the neural network and the associated NN data (including neural network structure, trained weights and parameters, and other NN data used or generated) while the AI application is executing. The memory can be system memory or any memory accessible by the system or application. The illustrated memory structures can be created and/or used within the system 100 (FIG. 1, already discussed).

Turning to FIG. 2A, a memory structure 200 is shown. The memory structure 200 includes a plurality of memory blocks, where the memory blocks are organized into N+1 groups: Group_0 (label 201), Group_1 (label 202), Group_2 (label 203), . . . Group_N (label 204). Each group has M+1 memory blocks. The size of M can vary among different groups. As illustrated in FIG. 2A, the memory blocks can be identified by group number. For example, Group_0 (label 201) can have memory blocks Block (0,0), Block (0,1), . . . . Block (0,M); Group_1 (label 202) can have memory blocks Block (1,0), Block (1,1), . . . . Block (1,M); and so forth. The memory blocks can occupy memory space in system memory or any memory space allocated for use by the AI application. The memory space can include, for example, a stack space and/or a heap space.

Memory blocks within a particular group typically are of the same size blocks. In some embodiments, different groups can have memory blocks of a size that can differ group-to-group. Generating a memory structure where groups have varying block sizes can increase the level of protection of the neural network, as the differing groups of block sizes can make it more difficult for a malicious party to determine storage or access patterns. As an example, the memory blocks in Group_0 can each be of a size 4 k (an example basic block size), the memory blocks in Group_1 can each be of a size 8 k, the memory blocks in Group_2 can each be of a size 16 k, and so forth. For example, memory blocks in Group_i can be of a size 2i×Qk, where i is the group number, and Q is the basic block size (in kilobytes) In some embodiments, Q=4. It will be understood that a variety of block sizes can be used for the different groups, and the block sizes can be selected from among a set of block sizes (such as, e.g., a set of block sizes determined by a formula). In some embodiments, each group can have memory blocks with the same block size. In embodiments, the memory structure 200 can be organized as a table of indices to a list of data chunks (e.g., blocks of size Qk or 2i×Qk).

Turning now to FIG. 2B, a memory structure 220 is shown. Similar to the memory structure 200 (FIG. 2A, already discussed), the memory structure 220 includes a plurality of memory blocks, where the memory blocks are organized into groups. The memory structure 220 spans two memory spaces, a stack space and a heap space. Generating a memory structure using both a stack space and a heap space can increase the level of protection of the neural network, as the differing memory spaces can make it more difficult for a malicious party to determine storage or access patterns. The stack space is statically allocated by the system 100 (e.g., by an operating system or an AI application running on system 100), and includes R+1 groups: Stack_Group_0 (label 221), Stack_Group_1 (label 222), Stack_Group_2 (label 223), . . . Stack_Group_R (label 224). The heap space is dynamically allocated by the AI application, and includes P+1 groups: Heap_Group_0 (label 231), Heap_Group_1 (label 232), Heap_Group_2 (label 233), . . . Heap_Group_P (label 234). Similar to the groups of memory blocks in the memory structure 200 (FIG. 2A, already discussed), the groups of memory blocks in the memory structure 220 can have blocks of varying sizes per group, or can have blocks all of the same size. It will be understood that the number of groups in stack space and heap space can be the same or different, and the number of memory blocks in each group can be the same or can differ between stack space and heap space. It will be further understood that the relative amount of stack space and heap space can vary from one implementation to the next.

As illustrated in FIG. 2B, the memory blocks can be identified by space and group number. For example, groups in the stack space can have J+1 memory blocks, such that Stack_Group_0 (label 221) has memory blocks S_Block (0,0), S_Block (0,1), . . . S_Block (0,J); Stack_Group_1 (label 222) has memory blocks S_Block (1,0), S_Block (1,1), . . . . S_Block (1,J); . . . Stack_Group_R (label 224) has memory blocks S_Block (R,0), S_Block (R,1), . . . S_Block (R,J). Similarly, groups in the heap space can have K+1 memory blocks, such that Heap_Group_0 (label 231) has memory blocks H_Block (0,0), H_Block (0,1), . . . H_Block (0,K); Heap_Group_1 (label 232) has memory blocks labeled H_Block (1,0), H_Block (1,1) . . . H_Block (1,M); and so forth. The sizes of J and/or K can vary among different groups.

Turning now to FIG. 2C, a stack space for a memory structure 250 is shown. The stack space illustrated in FIG. 2C is similar to the stack space in the memory structure 220 (FIG. 2B, already discussed), with the following differences. Each group of memory blocks in the stack space has an additional slot that provides a listing of available (i.e., unused) memory blocks within the group. For example, each of the available listing blocks (such as, e.g., Available_R) can be a linked list of unused memory blocks (such as, e.g., blocks in Stack_Group_R), which memory block has a pointer pointing to the next available memory block in the group. When there is need to use a memory block in a group, any block (usually the first block) in the group list will be used and removed from the available linked list. For example, as illustrated in FIG. 2C, Stack_Group_0 (label 251) has available memory blocks S_Block (0,0) (label 253) and S_Block (0,J) (label 254); these available blocks are listed in the slot Available_0 (label 255). Similarly, Stack_Group_R (label 252) has available memory blocks S_Block (R,1) (label 256) and S_Block (R,J) (label 257); these available blocks are listed in the slot Available_R (label 258). In some embodiments, the memory structure 250 can also have a heap space with available block lists (not shown in FIG. 2C) similar to the heap space in the memory structure 220 (FIG. 2B, already discussed).

FIGS. 3A-3B provide diagrams of examples of scattering a neural network in a neural network memory structure according to one or more embodiments, with reference to components and features described herein including but not limited to the figures and associated description. In the examples of FIGS. 3A-3B, each layer of the neural network (with weights, parameters, etc.) has been divided into chunks. Turning to FIG. 3A, the diagram illustrates a scattered neural network 300, where the neural network layers are divided into chunks, with the chunks stored in memory blocks of a memory structure (such as, e.g., the memory structure 220 in FIG. 2B, already discussed), where the order of memory blocks used to store the neural network is selected based on a randomized memory storage pattern. In embodiments, the size of each chunk can be selected randomly in a certain range. Once a chunk size is selected, then the memory block size can be determined, such as, e.g., the smallest memory block that can store the data chunk.

Thus, as illustrated in FIG. 3A, the scattered neural network 300 has a NN head 302, a first element (e.g., chunk) 304 stored in block S_Block (R,0), a second element (e.g., chunk) 306 stored in H_Block (2,1) and so forth. The NN head 302 stores the address of the first memory block holding neural network data. In some embodiments, the neural network thus divided into chunks and scattered among various memory blocks can be represented or identified as a chain of indexed values for each of the memory blocks used for the neural network.

Turning now to FIG. 3B, the diagram illustrates a scattered neural network 320, which is similar to the scattered neural network 300 (FIG. 3A), with the following differences. Each of the chunks of data are encrypted when stored in the respective memory blocks. In some embodiments, the data chunks are encrypted with encryption keys that can change from one memory block to the next. For example, as illustrated in FIG. 3B, the scattered neural network 320 has a NN head 322, a first element (e.g., chunk) 324 encrypted with a key (key identifier KeyID-0) stored in block S_Block (R,0), a second element (e.g., chunk) 326 encrypted with a key (key identifier KeyID-2) stored in H_Block (2,1) and so forth. In embodiments, each of the key identifiers used for encrypting chunks in the scattered neural network 320 can be stored along with the respective memory block index. In some embodiments, a single encryption key can be used to encrypt all data chunks for each of the memory blocks. In embodiments, the encryption key(s) can be symmetric keys.

FIG. 3C provides a diagram illustrating an example of an encryption key table 350 for an in-memory neural network protection system according to one or more embodiments, with reference to components and features described herein including but not limited to the figures and associated description. The encryption key table 350 can include entries for key identifiers, keys, timestamps, and number of chunks for which the key is being used. For example, a first row 352 of the key table 350 can include a key identifier 354 (KeyID-0), a corresponding key 356 (Key0), a timestamp 358 to indicate when the key (Key0) was used for encrypting one or more chunks of data, and a number of chunks 360 to indicate how may data chunks have been encrypted with the key (Key0). In some embodiments, the timestamp can indicate a time (day, date, time, etc.) when the key is to expire. The table can have a separate row (or a separate group of entries) for each key in use. In some embodiments, the key is used for only a single memory block. In some embodiments, each key table row can also include an index for the memory block(s) storing data encrypted by that respective key.

FIG. 4 provides a flow diagram illustrating an example process flow 400 for scattering a neural network in a neural network memory structure according to one or more embodiments, with reference to components and features described herein including but not limited to the figures and associated description. The process 400 can be implemented in a computing system such as, e.g., the computing system 100 (FIG. 1, already discussed), or the system 10 (described herein with reference to FIG. 7). The process 400 can be performed by or under direction of an operating system (e.g., an operating system running on the computing system 100 or the computing system 10). More particularly, the process 400 can be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, general purpose microprocessor or TTL technology, or any combination thereof. Moreover, the configurable and/or fixed-functionality hardware may be implemented via CMOS technology.

For example, computer program code to carry out operations shown in process 400 may be written in any combination of one or more programming languages, including an object oriented programming language such as JAVA, SMALLTALK, C++ or the like and conventional procedural programming languages, such as the “C” programming language or similar programming languages. Additionally, logic instructions can include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The process 400 can generally be performed when an AI application is loading a neural network into memory for execution. A computing system implementing the process flow 400 for scattering a neural network can include, or be in data communication with, memory such as system memory, which can include stack memory space and/or heap memory space, in which to generate the neural network memory structure for storing the scattered neural network. When loading the neural network data into memory, the layers of the network data will be split randomly into chunk sizes (e.g., size of 2i*4K bytes), and the actual memory for a particular chunk can be randomly chosen from stack space or heap space.

Turning to FIG. 4, illustrated processing block 402 provides for initialization of a memory structure generation module (such as, e.g., the NN memory structure module 101 in FIG. 1, already discussed). If stack memory space is to be used in the neural network memory structure, the stack memory allocation can occur with initialization of the memory structure module. Illustrated processing block 404 provides for building the memory structure, e.g., a stack memory structure. The stack memory structure can correspond to the stack space illustrated as part of the neural network memory structure 220 (FIG. 2B, already discussed), or the neural network memory structure 250 (FIG. 2C, already discussed). In embodiments, the memory structure can correspond to the general neural network memory structure 200 (FIG. 2A, already discussed). Illustrated processing block 406 provides for initializing encryption keys, to be used for encrypting the data chunks when stored in the memory blocks of the neural network memory structure. The encryption keys can be, e.g., symmetric keys.

The scatter/storage portion of process flow 400 begins at illustrated processing block 408. In embodiments, where the neural network memory structure has already been generated, the process flow 400 can skip to block 408. The scatter portion involves dividing the neural network into chunks, performed on a layer-by-layer basis. At illustrated processing block 410, a check is made to determine if the neural network storage (scatter) is complete. If yes (neural network fully scattered), the process ends (block 430). If no, the process continues to block 412, where a layer of the neural network is split from the remainder of the neural network. The layer will be further split (divided) into chunks. At illustrated processing block 414, a check is made to determine if the layer is done. If yes (layer done), the process returns to block 410. If no, the process continues to illustrated processing block 416, which provides for splitting the layer into chunks. The chunk size can be, e.g., the size of memory blocks of a particular group. Illustrated processing block 418 provides for determining whether stack space or heap space is to be used for a memory block to store the current chunk(s). The determination to use stack space or heap space for the current memory block can, in some embodiments, be a random determination. If yes (use stack space), the process continues to illustrated processing block 420, which provides for determining if the stack has space (e.g., one or more memory blocks that are unused and available). If yes at block 420 (stack space available), a memory block in the stack space is selected and the process continues to block 426. If no at block 420, the process continues at block 422. If no at block 418 (use heap space), the process continues to block 422.

Illustrated processing block 422 provides for determining whether to reuse existing heap space. If yes (reuse existing heap space), a memory block is selected from existing heap space and the process continues to block 426. If no, additional heap space is allocated at illustrated processing block 424 and a memory block is selected from the newly-allocated heap space. The process then continues at block 426.

Illustrated processing block 426 provides for choosing an encryption key for the current chunk. The encryption key can be selected from encryption keys already generated (e.g., in the encryption key table 350), or can be a newly-generated key. If the selected key is an existing key from the key table, the number of chunks entry for the corresponding key can be incremented. For a newly-generated key, the key can be added to the key table. Illustrated processing block 428 provides for encrypting the current data chunk with the selected key and storing the encrypted chunk in the selected memory block. The process then returns to block 414.

In some embodiments, if encryption is not used, the portions of process 400 relating to encryption (including, e.g., blocks 426 and 428) are bypassed or otherwise are not performed (or not present).

FIGS. 5A-5C provide flow diagrams illustrating example process flows 500, 510 and 540 for reshuffling a neural network with key management in a neural network memory structure according to one or more embodiments, with reference to components and features described herein including but not limited to the figures and associated description. The processes 500, 510 and/or 540 can be implemented in a computing system such as, e.g., computing system 100 (FIG. 1, already discussed), or system 10 (described herein with reference to FIG. 7). The processes 500, 510 and/or 540 can be performed by or under direction of an operating system (e.g., an operating system running on computing system 100 or computing system 10). More particularly, the processes 500, 510 and/or 540 can be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, general purpose microprocessor or TTL technology, or any combination thereof. Moreover, the configurable and/or fixed-functionality hardware may be implemented via CMOS technology.

For example, computer program code to carry out operations shown in processes 500, 510 and/or 540 may be written in any combination of one or more programming languages, including an object oriented programming language such as JAVA, SMALLTALK, C++ or the like and conventional procedural programming languages, such as the “C” programming language or similar programming languages. Additionally, logic instructions can include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

A computing system implementing the process flows 500, 510 and/or 540 for reshuffling a neural network with key management can include, or be in data communication with, memory such as system memory, which can include stack memory space and/or heap memory space, for storing the reshuffled neural network.

Turning to FIG. 5A, the process 500 begins at illustrated processing block 502, which provides for collecting and modeling a memory access pattern for the neural network in operation. For example, tools such as memory heat maps can be used to determine a memory access pattern. The memory access pattern can be collected as apart of a thread launched by the scatter/reshuffle application or by the AI application. The access pattern for different memory addresses can be quite different, depending on the memory spaces used and the initial scatter pattern, memory access frequency, block size, read/write address space, etc.

At illustrated processing block 504, a check is made to determine if it is time to reshuffle the neural network. In embodiments, this determination can be based on a timer and/or an elapsed time since a previous reshuffle operation. The interval for reshuffling can be defined with consideration of a tradeoff between overhead for moving memory and the level of challenges set for potential attackers. In some embodiments, the interval can also be determined using the number of memory read operations, such as, for example, after 100 memory block reads or 5 full neural network memory reads. If no at block 504 (not time to reshuffle), the process returns to block 502; in some embodiments, the process continues at block 508 to perform key management. If yes (time to reshuffle), the process continues to illustrated processing block 506 to perform a reshuffle operation. After completing the reshuffle operation, the process continues with block 508 (key management). After the key management process is completed, the process can return to block 502 to be repeated (which can be repeated, e.g., at various or periodic intervals). Further details regarding the reshuffle operation are provided herein with reference to FIG. 5B; further details regarding key management are provided herein with reference to FIG. 5C. In some embodiments, if encryption is not used, the portions of process 500 relating to encryption (including, e.g., block 508) are bypassed or otherwise are not performed (or not present).

Turning now to FIG. 5B, the reshuffle process 510 begins at block 512, which provides for comparing the memory access pattern for the neural network with another memory access pattern. The other memory access pattern can be based on, e.g., a memory access pattern for the system 100 overall. Based on the comparison, a determination is made at block 514 whether to reshuffle the neural network memory. For example, if the memory access pattern for the neural network (AI application) is sufficiently close to the overall system memory, then no reshuffling is performed. If the memory access pattern for the neural network (AI application) is not sufficiently close to the overall system memory, then reshuffling is performed. If the determination at block 514 is no (no reshuffle), the process continues to block 524 (process end).

If yes at block 514 (reshuffle), the process continues to illustrated processing block 516, which provides for finding a memory region to store the reshuffled portions of the neural network. The memory region selected can be selected based on matching a desired memory access pattern, which can be the other memory access pattern (block 512). Illustrated processing block 518 provides for determining whether one or more suitable memory block(s) have been found. If yes, at block 520 one or more chunks are moved from one or more memory block(s) to the found memory block(s). The process then continues to block 524. If no at block 518 (suitable block(s) not found), a camouflage memory access is inserted into the operating AI application at illustrated processing block 522. The camouflage memory access can be chosen to mimic the neural network memory access pattern or the desired memory access pattern. The process then continues to block 524, where the process 510 ends. In some embodiments, a camouflage memory access can be inserted in addition to a reshuffle of data in the memory blocks. The process 510 can generally be substituted for block 506 (FIG. 5A, already discussed).

Turning now to FIG. 5C, the key management process 540 begins at illustrated processing block 542, which provides for iterating stack and heap used space—reviewing the encryption key expiration time for all memory blocks used for neural network data. Illustrated processing block 544 provides for determining whether any chunks have an expired encryption key. For example, a crawler thread can be used to scan through the memory space(s) to identify expired keys; expired keys can be replaced and the data chunk re-encrypted without understanding the data content and the sequence of the data inside the network. Determining whether any keys are expired can be based, e.g., on a timestamp for the key (e.g., the timestamp in the key table 350 of FIG. 3C) to determine an elapsed time for that key; in some embodiments the timestamp can indicate when the key was first used, such that expiration can further be based on an expiration parameter for determining when a key is to expire. If no at block 544 (unexpired key), the process continues to block 558 (process end). If yes (expired key), the process continues at block 546.

Illustrated processing block 546 provides for choosing (i.e., selecting) a new key for the impacted memory block(s). The selected key can be a newly-generated key, or one of the existing keys (e.g., a key in the key table 350). In some embodiments, the key can be selected at random from a key list (e.g., keys listed in the key table 350). If an existing key at block 548, the process continues to block 556. If no at block 548 (will be new key), a new key is created at illustrated processing block 550 and added to the key table. At illustrated processing block 552, a check is made to determine if there are any keys with 0 chunks (e.g., any unused keys). If no, the process continues to block 556. If yes (unused key), in some embodiments illustrated processing block 554, which provides for deleting the unused key (e.g., from the key table 350). In some embodiments, unused keys can remain in the key table 350 and be re-used in a subsequent pass through the key management process. Illustrated processing block 556 provides for re-encrypting the affected data chunks (i.e., the chunks having an expired key) with the newly-selected key. The process then proceeds to block 558, where the process 540 ends. The process 540 can also be repeated at various or periodic intervals. The process 540 can generally be substituted for block 508 (FIG. 5A, already discussed).

In some embodiments, the memory region sniffing and recognition problem can be modelled as a clustering problem. One cluster is a normal memory region, and another is the neural network model memory region. The problem can be solved by clustering, e.g., mixture Gaussian/k-clustering.

$$p ( x ) = {\sum }_{k = 1}^{K} {π}_{k} N ( x \vert {μ}_{k} , {Σ}_{k} ) \qquad EQ . 1 :$$

Equation (1) defines the probability of an observed memory pattern as the sum of k Gaussian Distributions, where:
x is an observed memory access pattern;
p(x) is the probability of x;
N is the Gaussian Distribution;
μₖ is a D-dimensional mean vector;
Σₖ is a D×D covariance matrix;
k is the k-th cluster; and
πₖ is a mixing coefficient.

Using an expectation-maximization algorithm, this problem can be solved iteratively by determining the parameters with the maximum posterior probability. An example of an iterative algorithm follows:
1. Perform random initialize of μₖ, Σₖ, πₖ for each k distribution;
2. In an “expectation” step, evaluate:

$$γ ( {Z}_{nk} ) = \frac{{π}_{k} N ( {x}_{n} \vert {μ}_{k} , {Σ}_{k} )}{{Σ}_{j = 1}^{K} {π}_{j} N ( {x}_{j} \vert {μ}_{j} , {Σ}_{j} )} \qquad EQ . 2 :$$

3. In a “maximization” step, re-calculate the parameters using above γ(zₙₖ):

$${μ}_{k}^{new} = \frac{1}{{N}_{k}} {\sum }_{n = 1}^{N} γ ( {z}_{nk} ) {x}_{n} \qquad EQ . 3 ( a ) :$$

$${Σ}_{k}^{new} = \frac{1}{{N}_{k}} {\sum }_{n = 1}^{N} γ ( {z}_{η k} ) ( {x}_{n} - {μ}_{k}^{new} ) {( {x}_{n} - {μ}_{k}^{new} )}^{T} \qquad EQ . 3 ( b ) :$$

$${π}_{k}^{new} = \frac{{N}_{k}}{N} \qquad EQ . 3 ( c ) :$$

where:

$${N}_{k} = {\sum }_{n = 1}^{N} γ ( {z}_{nk} ) \qquad EQ . 3 ( d ) :$$

4. Calculate log likelihood and check for convergence:

$$ln p ( X \vert μ , Σ , π ) = {\sum }_{n = 1}^{N} ln \{ {\sum }_{k = 1}^{K} {π}_{k} N ( {x}_{n} \vert {u}_{k} , {Σ}_{k} ) \} \qquad EQ . 4$$

5. When it converges, the final parameters are:

$${μ}_{k}^{final} = \frac{1}{{N}_{k}} {\sum }_{n = 1}^{N} γ ( {z}_{nk} ) {x}_{n} \qquad EQ . 5 ( a ) :$$

$${Σ}_{k}^{final} = \frac{1}{{N}_{k}} {\sum }_{n = 1}^{N} γ ( {z}_{η k} ) ( {x}_{n} - {μ}_{k}^{new} ) {( {x}_{n} - {μ}_{k}^{new} )}^{T} \qquad EQ . 5 ( b ) :$$

$${π}_{k}^{final} = \frac{{N}_{k}}{N} \qquad EQ . 5 ( c ) :$$

where:

$${N}_{k} = {{\sum }^{N}}_{n = 1} γ ( {z}_{nk} ) \qquad EQ . 5 ( d ) :$$

Based on a solution to this Gaussian mixtures clustering problem, a camouflage memory access can be added to increase protection of the neural network memory access. For example, a similar ambiguous normal memory access following the same pattern as the neural network memory access pattern can be used, or a re-selection of memory blocks used for storing the existing network data blocks can take the memory access pattern closer to an application memory access pattern or a system memory access pattern.

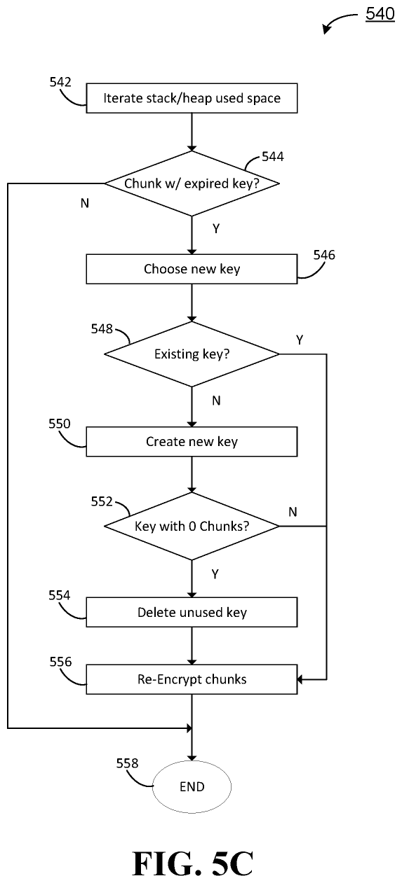

FIGS. 6A-6C provide flowcharts illustrating example methods 600, 620 and 640 relating to in-memory neural network protection according to one or more embodiments, with reference to components and features described herein including but not limited to the figures and associated description. The methods 600, 620 and/or 640 can generally be implemented in the system 100 (FIG. 1, already discussed), the system 10 (described herein with reference to FIG. 7), and/or using one or more of a CPU, a GPU, an AI accelerator, an FPGA accelerator, an ASIC, and/or via a processor with software, or in a combination of a processor with software and an FPGA or ASIC. More particularly, the methods 600, 620 and/or 640 can be implemented in one or more modules as a set of logic instructions stored in a non-transitory machine- or computer-readable storage medium such as RAM, read only memory ROM, PROM, firmware, flash memory, etc., in configurable logic such as, for example, PLAs, FPGAs, CPLDs, in fixed-functionality logic hardware using circuit technology such as, for example, ASIC, general purpose microprocessor or TTL technology, or any combination thereof. Moreover, the configurable and/or fixed-functionality hardware may be implemented via CMOS technology.

For example, computer program code to carry out operations shown in the methods 600, 620 and/or 640 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning to FIG. 6A, shown is a diagram illustrating the method 600 for in-memory neural network protection. Illustrated processing block 605 provides for generating a neural network memory structure having a plurality of memory blocks in a memory. The plurality of memory blocks can be organized into a plurality of groups of memory blocks. For each group, the memory blocks in the respective group can have a block size selected from a plurality of block sizes. The plurality of groups of memory blocks can be divided between stack space and heap space. Illustrated processing block 610 provides for scattering a neural network among the plurality of memory blocks based on a randomized memory storage pattern. Illustrated processing block 615 provides for reshuffling the neural network among the plurality of memory blocks based on a neural network memory access pattern.

Turning now to FIG. 6B, shown is a diagram illustrating the method 620 for scattering a neural network. The illustrated method 620 can generally be substituted for all or at least a portion of illustrated processing block 610 (FIG. 6A, already discussed). At illustrated processing block 625, each layer of the neural network is divided into a plurality of chunks. Illustrated processing block 630 provides, for each layer, selecting, for each chunk of the plurality of chunks, one of the plurality of memory blocks based on the randomized memory storage pattern. Illustrated processing block 635 provides for storing each chunk in the respective selected memory block. For each chunk, data for the chunk can be encrypted then stored in the respective selected memory block.

Turning now to FIG. 6C, shown is a diagram illustrating the method 640 for reshuffling a neural network. The illustrated method 640 can generally be substituted for all or at least a portion of illustrated processing block 615 (FIG. 6A, already discussed). At illustrated processing block 645, memory accesses for the neural network are measured over a time period. Illustrated processing block 650 provides for determining the neural network memory access pattern based on the measured memory accesses for the neural network. Illustrated processing block 655 provides for comparing the determined neural network memory access pattern and another memory access pattern. The other memory access pattern can be based on, e.g., a memory access pattern for the overall system or for the AI application. Illustrated processing block 660 provides for moving data for one or more of the stored chunks to one or more unused memory blocks of the plurality of memory blocks, based on the comparing. The method 640 can be repeated on a periodic basis. Reshuffling the neural network model can include inserting one or more camouflage memory accesses based on the determined neural network memory access pattern.

FIG. 7 shows a block diagram illustrating an example computing system 10 for in-memory neural network protection according to one or more embodiments, with reference to components and features described herein including but not limited to the figures and associated description. The system 10 can generally be part of an electronic device/platform having computing and/or communications functionality (e.g., server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof. In the illustrated example, the system 10 can include a host processor 12 (e.g., central processing unit/CPU) having an integrated memory controller (IMC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) subsystem 16. The I/O subsystem 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/or the I/O subsystem 16 can communicate with the storage 22 (all or portions thereof) via a network controller 24. In some embodiments, the system 10 can also include a graphics processor 26 (e.g., a graphics processing unit/GPU). In some embodiments, the system 10 can also include a graphics processor 26 (e.g., a graphics processing unit/GPU) and an AI accelerator 27. In an embodiment, the system 10 can also include a vision processing unit (VPU), not shown.

The host processor 12 and the I/O subsystem 16 can be implemented together on a semiconductor die as a system on chip (SoC) 11, shown encased in a solid line. The SoC 11 can therefore operate as a computing apparatus for in-memory neural network protection. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O subsystem 16 can execute program instructions 28 retrieved from the system memory 20 and/or the storage 22 to perform one or more aspects of the process 400, the process 500, the process 510, the process 540, the process 600, the process 620, and/or the process 640. The system 10 can implement one or more aspects of the system 100, the memory structure 200, the memory structure 220, the memory structure 250, the scattered neural network 300, and/or the scattered neural network 320. The system 10 is therefore considered to be performance-enhanced at least to the extent that the technology provides for increased protection of an operational neural network against malicious users.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touch-screen, keyboard, mouse, cursor-control device, touch-screen, microphone, digital camera, video recorder, camcorder, biometric scanners and/or sensors; input devices can be used to enter information and interact with system 10 and/or with other devices. The I/O devices 17 can also include one or more of output devices, such as a display (e.g., touch screen, liquid crystal display/LCD, light emitting diode/LED display, plasma panels, etc.), speakers and/or other visual or audio output devices. The input and/or output devices can be used, e.g., to provide a user interface.

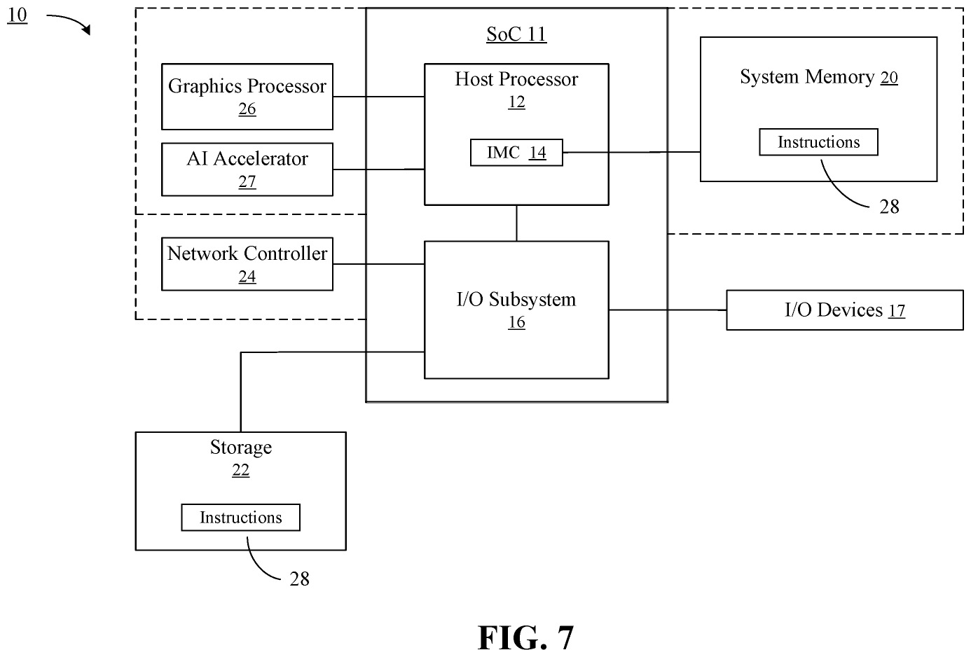

FIG. 8 shows a block diagram illustrating an example semiconductor apparatus 30 for in-memory neural network protection according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 7. The logic 34 can implement one or more aspects of the processes described above, including the process 400, the process 500, the process 510, the process 540, the process 600, the process 620, and/or the process 640. The logic 34 can implement one or more aspects of the system 100, the memory structure 200, the memory structure 220, the memory structure 250, the scattered neural network 300, and/or the scattered neural network 320. The apparatus 30 is therefore considered to be performance-enhanced at least to the extent that the technology provides for increased protection of an operational neural network against malicious users.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 34.

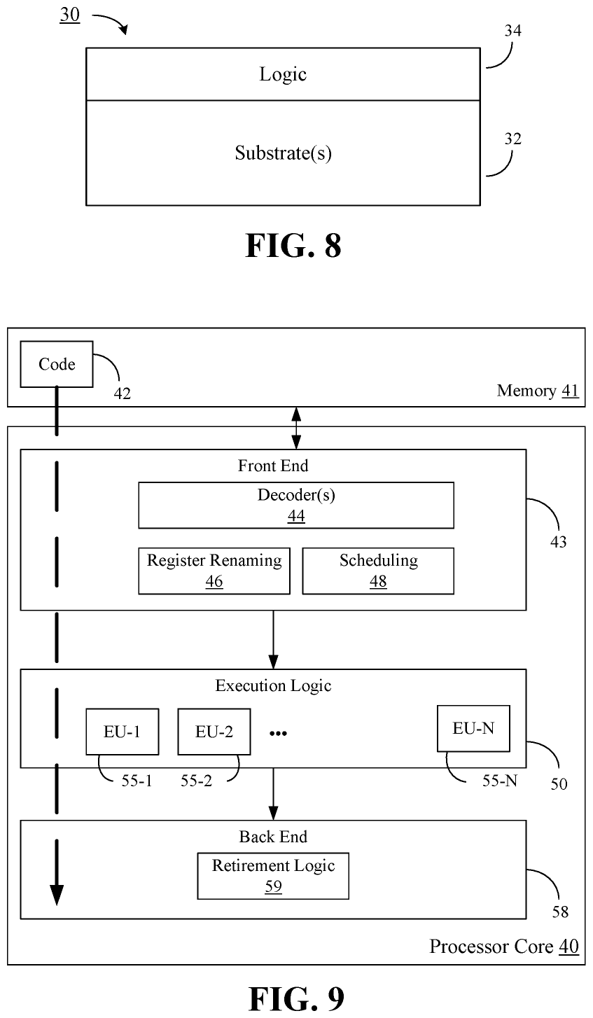

FIG. 9 is a block diagram illustrating an example processor core 40 according to one or more embodiments, with reference to components and features described herein including but not limited to the figures and associated description. The processor core 40 can be the core for any type of processor, such as a micro-processor, an embedded processor, a digital signal processor (DSP), a network processor, a graphics processing unit (GPU), or other device to execute code. Although only one processor core 40 is illustrated in FIG. 9, a processing element can alternatively include more than one of the processor core 40 illustrated in FIG. 9. The processor core 40 can be a single-threaded core or, for at least one embodiment, the processor core 40 can be multithreaded in that it can include more than one hardware thread context (or “logical processor”) per core.

FIG. 9 also illustrates a memory 41 coupled to the processor core 40. The memory 41 can be any of a wide variety of memories (including various layers of memory hierarchy) as are known or otherwise available to those of skill in the art. The memory 41 can include one or more code 42 instruction(s) to be executed by the processor core 40. The code 42 can implement one or more aspects of the process 400, the process 500, the process 510, the process 540, the process 600, the process 620, and/or the process 640. The processor core 40 can implement one or more aspects of the system 100, the memory structure 200, the memory structure 220, the memory structure 250, the scattered neural network 300, and/or the scattered neural network 320. The processor core 40 can follow a program sequence of instructions indicated by the code 42. Each instruction can enter a front end portion 43 and be processed by one or more decoders 44. The decoder 44 can generate as its output a micro operation such as a fixed width micro operation in a predefined format, or can generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments can include a number of execution units dedicated to specific functions or sets of functions. Other embodiments can include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 can take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 9, a processing element can include other elements on chip with the processor core 40. For example, a processing element can include memory control logic along with the processor core 40. The processing element can include I/O control logic and/or can include I/O control logic integrated with memory control logic. The processing element can also include one or more caches.

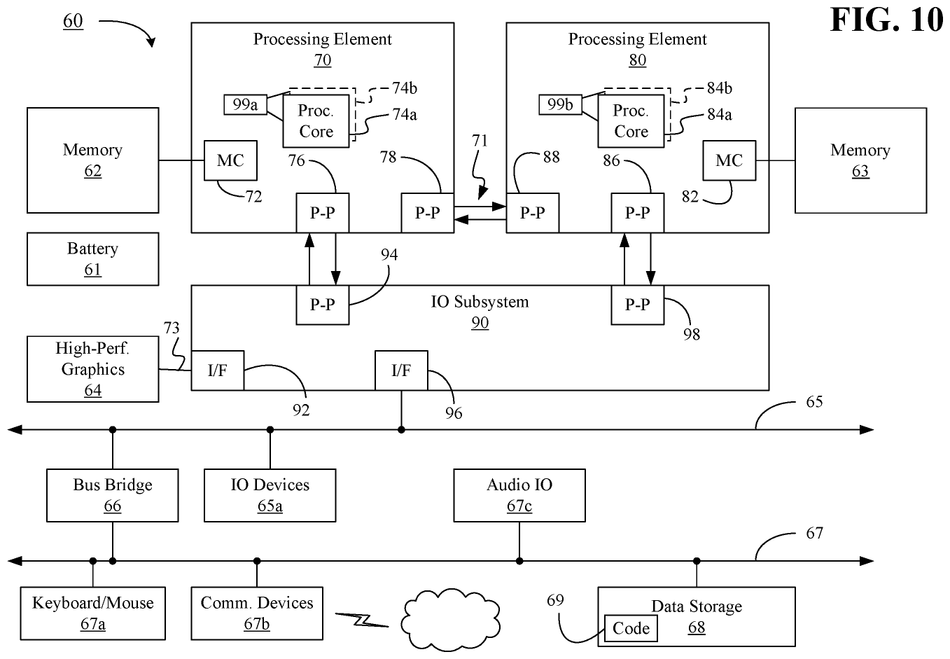

FIG. 10 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 can also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 10 can be implemented as a multi-drop bus rather than point-to-point interconnect.

As shown in FIG. 10, each of the processing elements 70 and 80 can be multicore processors, including first and second processor cores (i.e., processor cores 74a and 74b and processor cores 84a and 84b). Such cores 74a, 74b, 84a, 84b can be configured to execute instruction code in a manner similar to that discussed above in connection with FIG. 9.

Each processing element 70, 80 can include at least one shared cache 99a, 99b. The shared cache 99a, 99b can store data (e.g., instructions) that are utilized by one or more components of the processor, such as the cores 74a, 74b and 84a, 84b, respectively. For example, the shared cache 99a, 99b can locally cache data stored in a memory 62, 63 for faster access by components of the processor. In one or more embodiments, the shared cache 99a, 99b can include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements can be present in a given processor. Alternatively, one or more of the processing elements 70, 80 can be an element other than a processor, such as an accelerator or a field programmable gate array. For example, additional processing element(s) can include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences can effectively manifest themselves as asymmetry and heterogeneity amongst the processing elements 70, 80. For at least one embodiment, the various processing elements 70, 80 can reside in the same die package.

The first processing element 70 can further include memory controller logic (MC) 72 and point-to-point (P-P) interfaces 76 and 78. Similarly, the second processing element 80 can include a MC 82 and P-P interfaces 86 and 88. As shown in FIG. 10, MC's 72 and 82 couple the processors to respective memories, namely a memory 62 and a memory 63, which can be portions of main memory locally attached to the respective processors. While the MC 72 and 82 is illustrated as integrated into the processing elements 70, 80, for alternative embodiments the MC logic can be discrete logic outside the processing elements 70, 80 rather than integrated therein.

The first processing element 70 and the second processing element 80 can be coupled to an I/O subsystem 90 via P-P interconnects 76 and 86, respectively. As shown in FIG. 10, the I/O subsystem 90 includes P-P interfaces 94 and 98. Furthermore, the I/O subsystem 90 includes an interface 92 to couple I/O subsystem 90 with a high performance graphics engine 64. In one embodiment, a bus 73 can be used to couple the graphics engine 64 to the I/O subsystem 90. Alternately, a point-to-point interconnect can couple these components.

In turn, the I/O subsystem 90 can be coupled to a first bus 65 via an interface 96. In one embodiment, the first bus 65 can be a Peripheral Component Interconnect (PCI) bus, or a bus such as a PCI Express bus or another third generation I/O interconnect bus, although the scope of the embodiments are not so limited.

As shown in FIG. 10, various I/O devices 65a (e.g., biometric scanners, speakers, cameras, and/or sensors) can be coupled to the first bus 65, along with a bus bridge 66 which can couple the first bus 65 to a second bus 67. In one embodiment, the second bus 67 can be a low pin count (LPC) bus. Various devices can be coupled to the second bus 67 including, for example, a keyboard/mouse 67a, communication device(s) 67b, and a data storage unit 68 such as a disk drive or other mass storage device which can include code 69, in one embodiment. The illustrated code 69 can implement one or more aspects of the processes described above, including the process 400, the process 500, the process 510, the process 540, the process 600, the process 620, and/or the process 640. The illustrated code 69 can be similar to the code 42 (FIG. 9), already discussed. Further, an audio I/O 67c can be coupled to second bus 67 and a battery 61 can supply power to the computing system 60. The system 60 can implement one or more aspects of the system 100, the memory structure 200, the memory structure 220, the memory structure 250, the scattered neural network 300, and/or the scattered neural network 320.

Note that other embodiments are contemplated. For example, instead of the point-to-point architecture of FIG. 10, a system can implement a multi-drop bus or another such communication topology. Also, the elements of FIG. 10 can alternatively be partitioned using more or fewer integrated chips than shown in FIG. 10.

Embodiments of each of the above systems, devices, components and/or methods, including the system 10, the semiconductor apparatus 30, the processor core 40, the system 60, the system 100, the memory structure 200, the memory structure 220, the memory structure 250, the scattered neural network 300, the scattered neural network 320, the process 400, the process 500, the process 510, the process 540, the process 600, the process 620, and/or the process 640, and/or any other system components, can be implemented in hardware, software, or any suitable combination thereof. For example, hardware implementations can include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), general purpose microprocessor or TTL technology, or any combination thereof. Moreover, the configurable and/or fixed-functionality hardware may be implemented via CMOS technology.

Alternatively, or additionally, all or portions of the foregoing systems and/or components and/or methods can be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C # or the like and conventional procedural programming languages, such as the “C” programming language or similar programming languages.

### Additional Notes and Examples

Example 1 includes a computing system comprising a memory to store a neural network, and a processor to execute instructions that cause the computing system to generate a neural network memory structure having a plurality of memory blocks in the memory, scatter the neural network among the plurality of memory blocks based on a randomized memory storage pattern, and reshuffle the neural network among the plurality of memory blocks based on a neural network memory access pattern.

Example 2 includes the computing system of Example 1, wherein the plurality of memory blocks are organized into a plurality of groups of memory blocks, and wherein, for each group, the memory blocks in the respective group have a block size selected from a plurality of block sizes.

Example 3 includes the computing system of Example 1, wherein the plurality of memory blocks are organized into a plurality of groups of memory blocks, and wherein the plurality of groups of memory blocks are divided between stack space and heap space.

Example 4 includes the computing system of Example 1, wherein to scatter the neural network model comprises to divide each layer of the neural network into a plurality of chunks, for each layer, select, for each chunk of the plurality of chunks, one of the plurality of memory blocks based on the randomized memory storage pattern, and store each chunk in the respective selected memory block.

Example 5 includes the computing system of Example 4, wherein the instructions, when executed, further cause the computing system to, for each chunk, encrypt data for the chunk stored in the respective selected memory block.

Example 6 includes the computing system of Example 1, wherein to reshuffle the neural network model comprises to measure memory accesses for the neural network over a time period, determine the neural network memory access pattern based on the measured memory accesses for the neural network, compare the determined neural network memory access pattern and another memory access pattern, and based on the compare, move data for one or more of the stored chunks to one or more unused memory blocks of the plurality of memory blocks.

Example 7 includes the computing system of Example 6, wherein the instructions, when executed, further cause the computing system to repeat the reshuffling of the neural network.

Example 8 includes the computing system of any one of Examples 1-7, wherein to reshuffle the neural network model further comprises to insert one or more camouflage memory accesses based on the determined neural network memory access pattern.

Example 9 includes at least one computer readable storage medium comprising a set of instructions which, when executed by a computing system, cause the computing system to generate a neural network memory structure having a plurality of memory blocks in a memory, scatter a neural network among the plurality of memory blocks based on a randomized memory storage pattern, and reshuffle the neural network among the plurality of memory blocks based on a neural network memory access pattern.

Example 10 includes the at least one computer readable storage medium of Example 9, wherein the plurality of memory blocks are organized into a plurality of groups of memory blocks, and wherein, for each group, the memory blocks in the respective group have a block size selected from a plurality of block sizes.

Example 11 includes the at least one computer readable storage medium of Example 9, wherein the plurality of memory blocks are organized into a plurality of groups of memory blocks, and wherein the plurality of groups of memory blocks are divided between stack space and heap space.

Example 12 includes the at least one computer readable storage medium of Example 9, wherein to scatter the neural network model comprises to divide each layer of the neural network into a plurality of chunks, for each layer, select, for each chunk of the plurality of chunks, one of the plurality of memory blocks based on the randomized memory storage pattern, and store each chunk in the respective selected memory block.

Example 13 includes the at least one computer readable storage medium of Example 12, wherein the instructions, when executed, further cause the computing system to, for each chunk, encrypt data for the chunk stored in the respective selected memory block.

Example 14 includes the at least one computer readable storage medium of Example 9, wherein to reshuffle the neural network model comprises to measure memory accesses for the neural network over a time period, determine the neural network memory access pattern based on the measured memory accesses for the neural network, compare the determined neural network memory access pattern and another memory access pattern, and based on the compare, move data for one or more of the stored chunks to one or more unused memory blocks of the plurality of memory blocks.

Example 15 includes the at least one computer readable storage medium of Example 14, wherein the instructions, when executed, further cause the computing system to repeat the reshuffling of the neural network.

Example 16 includes the at least one computer readable storage medium of any one of Examples 9-15, wherein to reshuffle the neural network model further comprises to insert one or more camouflage memory accesses based on the determined neural network memory access pattern.

Example 17 includes a method comprising generating a neural network memory structure having a plurality of memory blocks in a memory, scattering a neural network among the plurality of memory blocks based on a randomized memory storage pattern, and reshuffling the neural network among the plurality of memory blocks based on a neural network memory access pattern.

Example 18 includes the method of Example 17, wherein the plurality of memory blocks are organized into a plurality of groups of memory blocks, and wherein, for each group, the memory blocks in the respective group have a block size selected from a plurality of block sizes.

Example 19 includes the method of Example 17, wherein the plurality of memory blocks are organized into a plurality of groups of memory blocks, and wherein the plurality of groups of memory blocks are divided between stack space and heap space.

Example 20 includes the method of Example 17, wherein scattering the neural network model comprises dividing each layer of the neural network into a plurality of chunks, for each layer, selecting, for each chunk of the plurality of chunks, one of the plurality of memory blocks based on the randomized memory storage pattern, and storing each chunk in the respective selected memory block.

Example 21 includes the method of Example 20, further comprising, for each chunk, encrypting data for the chunk stored in the respective selected memory block.

Example 22 includes the method of Example 17, wherein reshuffling the neural network model comprises measuring memory accesses for the neural network over a time period, determining the neural network memory access pattern based on the measured memory accesses for the neural network, comparing the determined neural network memory access pattern and another memory access pattern, and based on the comparing, moving data for one or more of the stored chunks to one or more unused memory blocks of the plurality of memory blocks.

Example 23 includes the method of Example 22, further comprising repeating the reshuffling of the neural network.

Example 24 includes the method of any one of Examples 17-23, wherein reshuffling the neural network model further comprises inserting one or more camouflage memory accesses based on the determined neural network memory access pattern.

Example 25 includes an apparatus comprising means for performing the method of any one of claims 17-23.

Example 26 includes a semiconductor apparatus comprising one or more substrates, and logic coupled to the one or more substrates, wherein the logic is implemented at least partly in one or more of configurable logic or fixed-functionality hardware logic, the logic to generate a neural network memory structure having a plurality of memory blocks in the memory, scatter the neural network among the plurality of memory blocks based on a randomized memory storage pattern, and reshuffle the neural network among the plurality of memory blocks based on a neural network memory access pattern.

Example 27 includes the semiconductor apparatus of Example 26, wherein the plurality of memory blocks are organized into a plurality of groups of memory blocks, and wherein, for each group, the memory blocks in the respective group have a block size selected from a plurality of block sizes.

Example 28 includes the semiconductor apparatus of Example 26, wherein the plurality of memory blocks are organized into a plurality of groups of memory blocks, and wherein the plurality of groups of memory blocks are divided between stack space and heap space.

Example 29 includes the semiconductor apparatus of Example 26, wherein to scatter the neural network model comprises to divide each layer of the neural network into a plurality of chunks, for each layer, select, for each chunk of the plurality of chunks, one of the plurality of memory blocks based on the randomized memory storage pattern, and store each chunk in the respective selected memory block.

Example 30 includes the semiconductor apparatus of Example 29, wherein the logic is further to, for each chunk, encrypt data for the chunk stored in the respective selected memory block.

Example 31 includes the semiconductor apparatus of Example 26, wherein to reshuffle the neural network model comprises to measure memory accesses for the neural network over a time period, determine the neural network memory access pattern based on the measured memory accesses for the neural network, compare the determined neural network memory access pattern and another memory access pattern, and based on the compare, move data for one or more of the stored chunks to one or more unused memory blocks of the plurality of memory blocks.

Example 32 includes the semiconductor apparatus of Example 31, wherein the logic is further to repeat the reshuffling of the neural network.

Example 33 includes the semiconductor apparatus of any one of Examples 26-32, wherein to reshuffle the neural network model further comprises to insert one or more camouflage memory accesses based on the determined neural network memory access pattern.

Example 33 includes the semiconductor apparatus of Example 26, wherein the logic coupled to the one or more substrates includes transistor channel regions that are positioned within the one or more substrates.

Embodiments are applicable for use with all types of semiconductor integrated circuit (“IC”) chips. Examples of these IC chips include but are not limited to processors, controllers, chipset components, PLAs, memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a memory to store a neural network; and
a processor to execute instructions that cause the computing system to:
generate a neural network memory structure having a plurality of memory blocks in the memory;
scatter the neural network among the plurality of memory blocks based on a randomized memory storage pattern; and
reshuffle the neural network among the plurality of memory blocks based on a neural network memory access pattern.

2. The computing system of claim 1, wherein the plurality of memory blocks are organized into a plurality of groups of memory blocks, and
wherein, for each group, the memory blocks in the respective group have a block size selected from a plurality of block sizes.

3. The computing system of claim 1, wherein the plurality of memory blocks are organized into a plurality of groups of memory blocks, and
wherein the plurality of groups of memory blocks are divided between stack space and heap space.

4. The computing system of claim 1, wherein to scatter the neural network model comprises to:
divide each layer of the neural network into a plurality of chunks;
for each layer, select, for each chunk of the plurality of chunks, one of the plurality of memory blocks based on the randomized memory storage pattern; and
store each chunk in the respective selected memory block.

5. The computing system of claim 4, wherein the instructions, when executed, further cause the computing system to, for each chunk, encrypt data for the chunk stored in the respective selected memory block.

6. The computing system of claim 1, wherein to reshuffle the neural network model comprises to:
measure memory accesses for the neural network over a time period;
determine the neural network memory access pattern based on the measured memory accesses for the neural network;
compare the determined neural network memory access pattern and another memory access pattern; and
based on the compare, move data for one or more of the stored chunks to one or more unused memory blocks of the plurality of memory blocks.

7. The computing system of claim 6, wherein the instructions, when executed, further cause the computing system to repeat the reshuffling of the neural network.

8. The computing system of claim 1, wherein to reshuffle the neural network model further comprises to insert one or more camouflage memory accesses based on the determined neural network memory access pattern.

9. At least one computer readable storage medium comprising a set of instructions which, when executed by a computing system, cause the computing system to:
generate a neural network memory structure having a plurality of memory blocks in a memory;
scatter a neural network among the plurality of memory blocks based on a randomized memory storage pattern; and
reshuffle the neural network among the plurality of memory blocks based on a neural network memory access pattern.

10. The at least one computer readable storage medium of claim 9, wherein the plurality of memory blocks are organized into a plurality of groups of memory blocks, and
wherein, for each group, the memory blocks in the respective group have a block size selected from a plurality of block sizes.

11. The at least one computer readable storage medium of claim 9, wherein the plurality of memory blocks are organized into a plurality of groups of memory blocks, and
wherein the plurality of groups of memory blocks are divided between stack space and heap space.

12. The at least one computer readable storage medium of claim 9, wherein to scatter the neural network model comprises to:
divide each layer of the neural network into a plurality of chunks;
for each layer, select, for each chunk of the plurality of chunks, one of the plurality of memory blocks based on the randomized memory storage pattern; and
store each chunk in the respective selected memory block.

13. The at least one computer readable storage medium of claim 12, wherein the instructions, when executed, further cause the computing system to, for each chunk, encrypt data for the chunk stored in the respective selected memory block.

14. The at least one computer readable storage medium of claim 9, wherein to reshuffle the neural network model comprises to:
measure memory accesses for the neural network over a time period;
determine the neural network memory access pattern based on the measured memory accesses for the neural network;
compare the determined neural network memory access pattern and another memory access pattern; and
based on the compare, move data for one or more of the stored chunks to one or more unused memory blocks of the plurality of memory blocks.

15. The at least one computer readable storage medium of claim 14, wherein the instructions, when executed, further cause the computing system to repeat the reshuffling of the neural network.

16. The at least one computer readable storage medium of claim 9, wherein to reshuffle the neural network model further comprises to insert one or more camouflage memory accesses based on the determined neural network memory access pattern.

17. A method comprising:
generating a neural network memory structure having a plurality of memory blocks in a memory;
scattering a neural network among the plurality of memory blocks based on a randomized memory storage pattern; and
reshuffling the neural network among the plurality of memory blocks based on a neural network memory access pattern.

18. The method of claim 17, wherein the plurality of memory blocks are organized into a plurality of groups of memory blocks, and
wherein, for each group, the memory blocks in the respective group have a block size selected from a plurality of block sizes.

19. The method of claim 17, wherein the plurality of memory blocks are organized into a plurality of groups of memory blocks, and
wherein the plurality of groups of memory blocks are divided between stack space and heap space.

20. The method of claim 17, wherein scattering the neural network model comprises:
dividing each layer of the neural network into a plurality of chunks;
for each layer, selecting, for each chunk of the plurality of chunks, one of the plurality of memory blocks based on the randomized memory storage pattern; and
storing each chunk in the respective selected memory block.

21. The method of claim 20, further comprising, for each chunk, encrypting data for the chunk stored in the respective selected memory block.

22. The method of claim 17, wherein reshuffling the neural network model comprises:
measuring memory accesses for the neural network over a time period;
determining the neural network memory access pattern based on the measured memory accesses for the neural network;
comparing the determined neural network memory access pattern and another memory access pattern; and
based on the comparing, moving data for one or more of the stored chunks to one or more unused memory blocks of the plurality of memory blocks.

23. The method of claim 22, further comprising repeating the reshuffling of the neural network.

24. The method of claim 17, wherein reshuffling the neural network model further comprises inserting one or more camouflage memory accesses based on the determined neural network memory access pattern.
